(19) United States
(12) Patent Application Publication
(10) Pub. No.: US 2026/0246314 A1
(43) Pub. Date: Aug. 20, 2026

(54) THERMAL CAP FOR STATOR WINDING

(71) Applicant: H3X TECHNOLOGIES INC., Louisville, CO (US)

(72) Inventors: Eric Paul Maciolek, Louisville, CO (US); Max Meyer Liben, Louisville, CO (US)

(21) Appl. No.: 19/161,403

(22) PCT Filed: Mar. 1, 2024
(86) PCT No.: PCT/US2024/018015

§ 371 Date: Sep. 2, 2025

Related U.S. Application Data
(60) Provisional application No. 63/487,965, filed on Mar. 2, 2023.

(51) Int. Cl. H02K 1/14; H02K 3/30; H02K 3/32; H02K 5/20

(52) U.S. Cl. CPC H02K 1/146; H02K 3/30; H02K 3/325; H02K 5/203

(57) ABSTRACT

A motor assembly comprising a stator including: a yoke with an axial end surface, an integral tooth extending radially inward from the yoke, and a segmented tooth extending radially inward from the yoke. The motor assembly further comprises a winding wound around the integral tooth; and a cap positioned at the axial end surface. The cap includes a rim portion aligned with the yoke and a tooth portion aligned with the segmented tooth. The cap is a thermal conductor and an electrical insulator, and the cap provides a thermal conduction path to extract heat from the end winding portions of the stator windings.

### CROSS-REFERENCE TO RELATED APPLICATIONS

This application is a U.S. 371 national phase entry of International Patent Application No. PCT/US2024/018015, filed Mar. 1, 2024, which claims the benefit of priority to U.S. Provisional Patent Application No. 63/487,965, filed Mar. 2, 2023, which is hereby incorporated by reference in its entirety.

### TECHNICAL FIELD

The present disclosure relates to cooling an electrical winding use in, for example, an integrated motor drive.

### BACKGROUND

Conventional stator windings have end winding portions that are challenging to thermally manage because the end winding portions are typically not in thermal contact with a component that provides an efficient thermal conduction path to a coolant medium. With no efficient thermal conduction path, heat generated in the end winding portions flows back into portions of the winding positioned within the stator slots, which ultimately raises the thermal load and temperature of the winding. One conventional strategy to cool end winding portions is to spray or splash oil, for example, onto the end turns, but requires complex pumping systems, additional seals, additional heat exchangers and more frequent maintenance.

### SUMMARY

The disclosure provides, in one aspect, a motor assembly comprising a stator including: a yoke with an axial end surface, an integral tooth extending radially inward from the yoke, and a segmented tooth extending radially inward from the yoke. The motor assembly further comprising a winding wound around the integral tooth; and a cap positioned at the axial end surface. The cap includes a rim portion aligned with the yoke and a tooth portion aligned with the segmented tooth.

In some embodiments, the cap abuts an end winding portion of the winding.

In some embodiments, the cap includes a first surface that abuts the winding, a second surface that abuts the windings, and a third surface that abuts the winding.

In some embodiments, the winding includes an end winding portion that extends from the stator, and the first surface, the second surface, and the third surface of the cap abut the end winding portion.

In some embodiments, the cap includes a fourth surface that abuts the yoke and the segmented tooth.

In some embodiments, the first surface, the second surface, and the third surface extend perpendicular to the fourth surface.

In some embodiments, the cap is at least partially positioned radially outward from the winding.

In some embodiments, an outer cylindrical surface of the stator is flush with an outer cylindrical surface of the cap.

In some embodiments, the cap does not overlap the integral tooth.

In some embodiments, the rim portion is ring shaped and spans 360 degrees around.

In some embodiments, the cap is ceramic.

In some embodiments, the cap is Aluminum Nitride ceramic.

In some embodiments, the motor assembly further includes a housing with a cooling channel positioned within the housing.

In some embodiments, an outer cylindrical surface of the cap abuts the housing, and an outer cylindrical surface of the stator abuts the housing.

In some embodiments, the integral tooth is one of a plurality of integral teeth and the segmented tooth is one of a plurality of segmented teeth, and wherein the cap is one of a plurality of caps.

In some embodiments, the plurality of caps is positioned at the axial end surface to form a ring that spans 360 degrees.

In some embodiments, the axial end surface is a first axial end surface and the cap is a first cap, and wherein the yoke further includes a second axial end surface, and the motor assembly further includes a second cap positioned at the second axial end surface.

In some embodiments, the segmented tooth includes a connection portion that is received within a slot formed in the yoke. The cap axially overlaps the connection portion and the slot.

In some embodiments, no winding is wound around the segmented tooth.

In some embodiments, the tooth portion of the cap is a first tooth portion, and the cap further includes a second tooth portion circumferentially spaced from the first tooth portion, with a receiving space defined between the first tooth portion and the second tooth portion. The receiving space is configured to at least partially receive the winding.

In some embodiments, the rim portion has an outer cylindrical surface and an inner cylindrical surface. The tooth portion extends from the inner cylindrical surface.

The disclosure provides, in one aspect, a motor assembly comprising a stator including: a yoke with an axial end surface, a tooth extending radially inward from the yoke, and a winding wound around the tooth. The motor assembly further includes a cap positioned at the axial end surface. the cap includes a rim portion aligned with the yoke.

In some embodiments, the cap abuts an end winding portion of the winding.

In some embodiments, the cap includes a surface that abuts the yoke.

In some embodiments, the cap is at least partially positioned radially outward from the winding.

In some embodiments, an outer cylindrical surface of the stator is flush with an outer cylindrical surface of the cap.

In some embodiments, the rim portion is ring shaped and spans 360 degrees around.

In some embodiments, the cap is ceramic.

In some embodiments, the cap is Aluminum Nitride ceramic.

In some embodiments, the motor assembly further includes a housing with a cooling channel positioned within the housing.

In some embodiments, an outer cylindrical surface of the cap abuts the housing, and an outer cylindrical surface of the stator abuts the housing.

In some embodiments, the cap is one of a plurality of caps, and wherein the plurality of caps is positioned at the axial end surface to form a ring that spans 360 degrees.

Other aspects of the disclosure will become apparent by consideration of the detailed description and accompanying drawings.

### BRIEF DESCRIPTION OF THE DRAWINGS

These and other features, aspects, and advantages of the present technology will become better understood with regards to the following drawings. The accompanying figures and examples are provided by way of illustration and not by way of limitation.

FIG. 1 is a perspective view of a motor assembly.

FIG. 2 is a cross-sectional view of a stator and stator windings.

FIG. 3 is an enlarged partial view of FIG. 2.

FIG. 4 is an enlarged perspective view of one axial end of the motor assembly illustrating a plurality of caps.

FIG. 5 is an exploded view of the axial end of the motor assembly of FIG. 4.

FIG. 6 is perspective view of one of the plurality of caps of FIG. 4.

FIG. 7 is a perspective view of a cap.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “coupled,” as used herein, is defined as “connected,” although not necessarily directly, and not necessarily mechanically. The term coupled is to be understood to mean physically, magnetically, chemically, fluidly, electrically, or otherwise coupled, connected or linked and does not exclude the presence of intermediate elements between the coupled elements absent specific contrary language.

The term “abut” or “abuts,” as used herein, refers to contact between two components such that a thermal conduction path between the components is established. Components that abut may have a layer of thermal grease, for example, positioned between the abutting components to further facilitate the thermal conduction path between the components.

As used herein, an “end winding portion” of a winding or stator winding refers to the portion or portions of the winding that extends axially beyond the stator. The end winding portion of a winding wound around a stator tooth is typically curved as the electrical conductors of the winding extend from one winding slot to another circumferentially spaced winding slot.

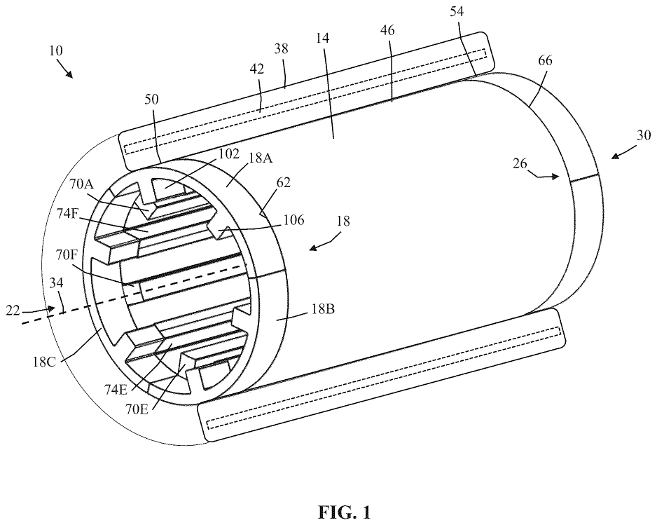

With reference to FIG. 1, a motor assembly 10 includes a stator 14, a first plurality of caps 18 at one axial end 22 of the stator 14, and a second plurality of caps 26 at another axial end 30 of the stator 14. The stator 14 defines a longitudinal axis 34 that extends through the axial ends 22, 30. In the illustrated embodiment, the first plurality of caps 18 and the second plurality of caps 26 are positioned around the longitudinal axis 34.

In the illustrated embodiment, the motor assembly 10 further includes a housing 38 with a cooling channel 42 positioned within the housing 38. In some embodiments, the cooling channel extends helically around the housing along a longitudinal axis of the housing. Such motor assembly with a housing and cooling channel is detailed in International Application Number PCT/US2021/0157691, which is incorporated herein by reference in its entirety. As detailed herein, the cooling channel 42 cools the stator 14, the first plurality of caps 14, and the second plurality of caps 18.

With continued reference to FIG. 1, in the illustrated embodiment, the stator 14, the first plurality of caps 18, and the second plurality of caps 26 are positioned within the housing 38. An outer cylindrical surface 46 of the stator 14 abuts the housing 38, providing a thermal conduction path from the stator 14 to the housing 38 and the cooling channel 42. In some embodiments, an outer cylindrical surface 50 of one or more of the first plurality of caps 18 abuts the housing 38, providing a thermal conduction path from the cap 18 to the housing 38 and the cooling channel 42. Likewise, in the illustrated embodiment, an outer cylindrical surface 54 of one or more of the second plurality of caps 26 abuts the housing 38, providing a thermal conduction path from the caps 26 to the housing 38 and the cooling channel 42. In other words, the housing 38 and the cooling channel 42 extend pass the axial ends 22, 30 of the stator 14 along the longitudinal axis 34 such that the housing 38 is also in direct thermal contact with first and second plurality of caps 18, 22. Advantageously, the cooling channel 42 in the housing 38 is able to effectively remove heat from the caps 18, 22, which as explained in greater detail herein is removed from end winding portions of the stator windings.

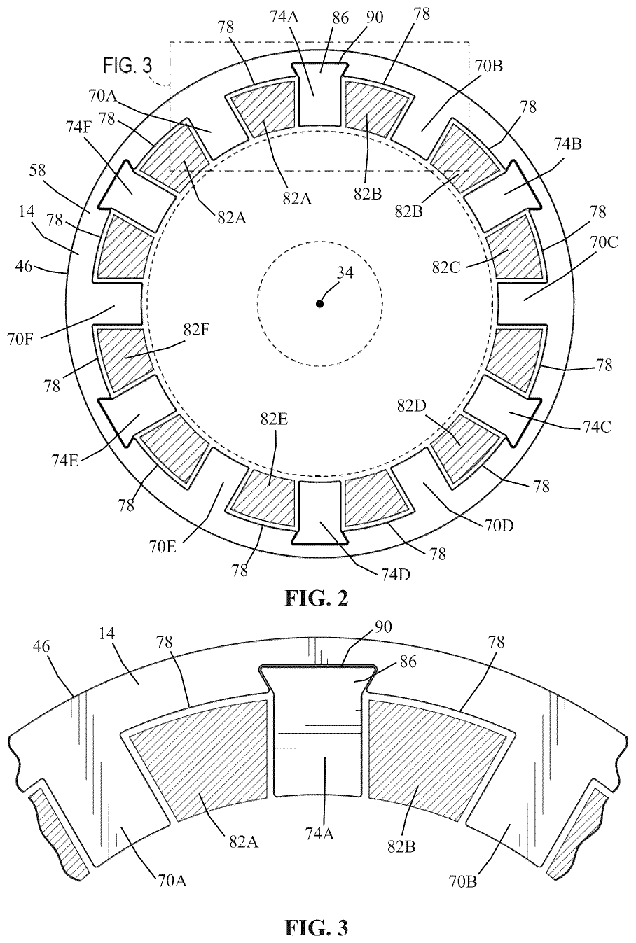

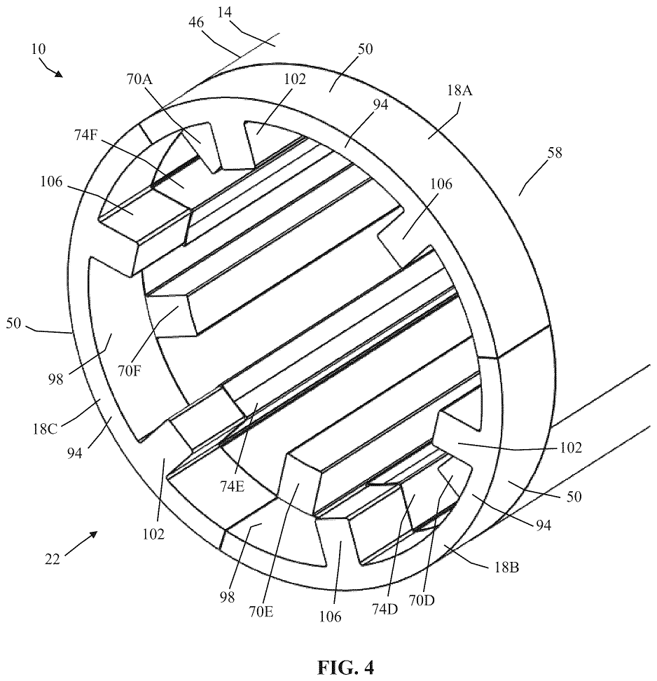

With reference to FIGS. 2 and 3, the stator 14 includes a yoke 58 with a first axial end surface 62 and a second axial end surface 66 positioned opposite the first axial end surface 62. In some embodiments, the yoke 58 is manufactured from stacked thin electrical steel laminations. In the illustrated embodiment, the axial end surfaces 62, 66 are the axial end surface of the stator lamination stack. In the illustrated embodiment, the stator 14 includes a plurality of integral teeth 70 (e.g., teeth 70A-70F), and a plurality of segmented teeth 74 (e.g., teeth 74A-74F). In the illustrated embodiment, the plurality of integral teeth 70 alternate with the plurality of segmented teeth 74 circumferentially around the yoke 58. For example, a first integral tooth 70A extends radially inward from the yoke 58 and the second integral tooth 70B extends radially inward from the yoke 58. Likewise, a first segmented tooth 74A extends radially inward from the yoke 58, and the first segmented tooth 74A is positioned circumferentially between the first integral tooth 70A and the second integral tooth 70B. A second segmented tooth 74B also extends radially inward from the yoke 58, and the second integral tooth 70B is positioned circumferentially between the first segmented tooth 74A and the second segmented tooth 74B. Unlike conventional fully segmented stators, the stator 14 described herein includes alternating integral teeth 70 and segmented teeth 74. In some embodiments, the stator includes integral teeth but does not include any segmented teeth.

With continued reference to FIG. 2, in the illustrated embodiment, a slot 78 (e.g., a winding slot) is defined between adjacent integral teeth 70 and segmented teeth 74. Each of the slots 78 at least partially receive at least one of a plurality of stator windings 82 (e.g., stator windings 82A-82F). In some embodiments, a first stator winding 82A is wound around the first integral tooth 70A and a second stator winding 82B is wound around the second integral tooth 70B, and the first segmented tooth 74A is positioned between the first winding 82A and the second winding 82B. In some embodiments, each stator winding 82 includes a wound electrical conductor and an encapsulant. In some embodiments, no winding is wound around the segmented teeth 74. In other words, every other stator tooth is wound in the illustrated embodiment, with six wound teeth (i.e., the six integral teeth 70) and six un-wound teeth (i.e., the six segmented teeth 74).

With reference to FIG. 4, the first plurality of caps 18 includes a first cap 18A, a second cap 18B, and a third cap 18C. In some embodiments, the first plurality of caps 18 or the second plurality of caps 26 include any number of caps. In some embodiments, the first plurality of caps 18 is replaced with a single, unitary cap. In some embodiments, the second plurality of caps 26 is replaced with a single, unitary cap.

The first cap 18A, the second cap 18B, and the third cap 18C are positioned at the first axial end surface 62 of the yoke 58. In some embodiments, the outer cylindrical surface 50 of each cap 18A, 18A, 18C is aligned (e.g., flush) with the outer cylindrical surface 46 of the stator 14. Likewise, the second plurality of caps 26 is positioned at the second axial end surface 66 of the yoke 58.

In some embodiments, the cap is ceramic (e.g., made of a ceramic material). In some embodiments, the cap is made of a Aluminum Nitride ceramic. In other embodiments, the cap is made of any suitable thermal conductor and electrical insulator. As such, the cap may also be referred to as a ceramic end cap or a thermal cap.

As detailed further herein, the caps 18, 26 are positioned and configured to abut an end winding portion of the stator windings 82. Specifically, the first plurality of caps 18 abut the end winding portions of the stator windings 82 that extend from the first axial end 22 of the stator 14, and the second plurality of caps 26 abut the end winding portions of the stator windings 82 that extend from the second axial end of 30 of the stator 14. The caps 18, 26 are at least partially positioned radially outward from the windings 82. In some embodiments, the caps 18, 26 are positioned in direct contact with the end winding portions of the stator windings 82. Advantageously, the caps 18, 26 provide an efficient thermal conduction path for heat generated in the end winding portions to be removed from the windings. For example, heat generated in the end winding portions is transferred via conduction to the caps 18, 26, and heat in the caps 18, 26 is transferred via conduction to the housing 38 and the cooling channel 42. As such, an improved heat conduction path is provided to remove heat generated in the end winding portions of the stator windings 82.

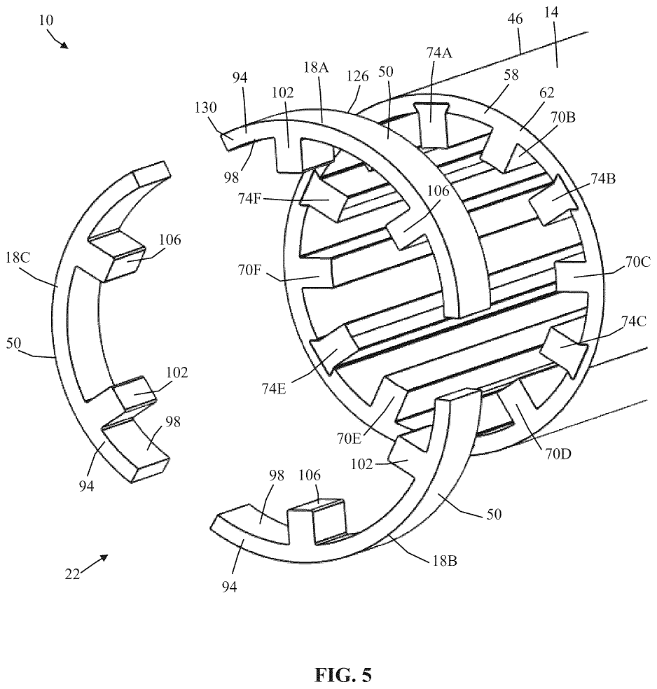

With reference to FIG. 5, in the illustrated embodiment, the first segmented tooth 74A includes a connection portion 86 that is received within a corresponding slot 90 formed in the yoke 58. In some embodiments, the second segmented tooth 74B and the other segmented teeth 74C-74F are structurally identical to the first segmented tooth 74A. As detailed further herein, at least one of the caps (e.g., cap 18A) axially overlaps the interface between the segmented tooth 74A and the yoke 58 (e.g., the connection portion 86 and the slot 90). As such, in some embodiments, the caps 18, 26 advantageously keep, or help keep, the segmented teeth 74A-74F locked axially in place relative to the yoke 58. In some embodiments, the stator 14, the windings 82, the first plurality of caps 18, and the second plurality of caps 26 are at least partially potted with a low-viscosity thermally conductive encapsulant after being installed in the housing 38. In some embodiments, a thermally conductive but electrically insulating encapsulant and/or resin fills any gaps that exist between the ceramic thermal caps and the housing or between the ceramic thermal caps and the end windings.

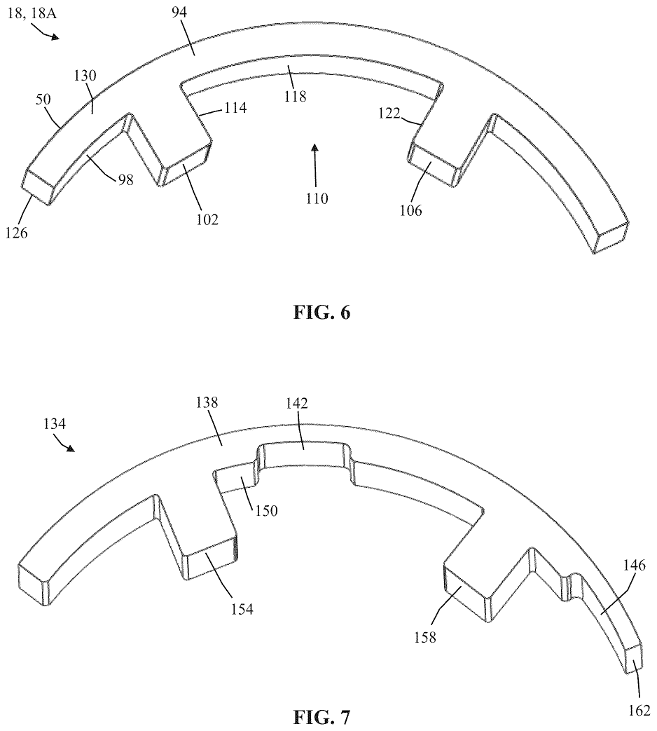

With reference to FIG. 6, the details of the first cap 18A are illustrated but the description can also apply equally to other similar caps (e.g., any one of the first plurality of caps 18 or any one of the second plurality of caps 26). Throughout this description “the first cap 18A” may be referred to as “the cap 18A,” and it should be understood the description may apply equally to any of the caps 18, 26. In the illustrated embodiment, the cap 18A includes a rim portion 94 that defines the outer cylindrical surface 50 and an inner cylindrical surface 98. The cap 18A further includes a first tooth portion 102 extending radially inward from the inner cylindrical surface 98, and a second tooth portion 106 extending radially inward from the inner cylindrical surface 98. A receiving space 110 is defined between the first tooth portion 102 and the second tooth portion 106, and the receiving space 110 is configured to at least partially receive an end winding portion of one of the stator windings 82. In some embodiments, the cap 18A includes any number of tooth portions forming any number of receiving spaces. In some embodiments, the receiving space 110 is defined between a tooth portion of one cap (e.g., cap 18A) and a tooth portion of an adjacent cap (e.g., cap 18B). In some embodiments the cap 18A includes a single tooth portion and the receiving space is defined between a tooth portion of an adjacent cap (e.g., cap 18B).

With reference to FIG. 5, the rim portion 94 of the caps 18 are aligned with the yoke 58, and the tooth portions 102, 106 of the caps 18 are aligned with the segmented teeth 74. For example, the first tooth portion 102 is aligned with the first segmented tooth 74A and the second tooth portion 106 is aligned with the second segmented tooth 74B. In the illustrated embodiment, the first tooth portion 102 extends radially inward the same distance as the first segmented tooth 74A. In the illustrated embodiment, the first tooth portion 102 has a width the same as the first segmented tooth 74. In other words, the profile of the first tooth portion 102 is the same as the first segmented tooth 74A. The caps 18 are aligned at the axial end 22 of the stator 14 to overlap the axial end surface 62 of the yoke 58 and the segmented teeth 74. None of the caps 18 overlap any of the integral teeth 70 (e.g., the caps 18 do not overlap the integral teeth 70).

With continued reference to FIG. 6, the cap 18A includes a plurality of surfaces that abut the end winding portion of the stator winding 82. For example, the cap 18A includes a first surface 114 that abuts the winding 82B, a second surface 118 that abuts the winding 82B, and a third surface 122 that abuts the winding 82B. More specifically, the surfaces 114, 118, 122 abut an end winding portion of the stator windings 82B. In the illustrated embodiment, the receiving space 110 is at least partially defined by the first surface 114, the second surface 118, and the third surface 122. In other words, the cap 18A at least partially envelops the end winding portion of the stator winding 82B.

With continued reference to FIG. 6, the cap 18A further includes a fourth surface 126 and a fifth surface 130. In the illustrated embodiment, the fourth surface 126 and the fifth surface 130 are axial end surfaces that are oriented perpendicular to the longitudinal axis 34. The fourth surface 126 abuts the yoke 58 and the segmented teeth 74. In other words, the fourth surface 126 of the cap 18A is positioned in a facing relationship with the axial end surface 22 of the yoke 58. In the illustrated embodiment, the first surface 114, the second surface 118, and the third surface 122 extend perpendicular to the fourth surface 126. In other words, the surfaces 114, 118, 122 are oriented parallel to the longitudinal axis 34.

In the illustrated embodiment, the rim portion 94 is ring shaped and spans approximately 120 degrees around the longitudinal axis 34. In the illustrated embodiment, the first cap 18A, the second cap 18B, and the third cap 18C together form a complete ring that spans 360 degrees around the longitudinal axis 34. In other words, the plurality of caps 18 is positioned at the axial end surface 62 to form a ring that spans 360 degrees. In some embodiments, the cap 18 is a single unitary cap where the rim portion is ring shaped and spans 360 degrees around the longitudinal axis 34.

In some embodiments, the cap has a rim portion but does not include a tooth portion. For example, in some embodiments where there is a winding wound around every tooth of the stator (e.g., a double layer winding), the cap forms at least part of a ring around the end turns and is positioned between the outer radial surface of the end turns and the housing inner radial surface. In other words, the cap is ring-shaped.

With reference to FIG. 7, a cap 134 according to another embodiment is illustrated. In some embodiments, the cap 234 is anyone of the caps 18, 26 described herein. The cap 134 is similar to the cap 18A of FIG. 6, with only the differences detailed herein. The cap 134 includes a rim portion 138 with notches 142, 146 formed in an inner cylindrical surface 150. The notch 142 is positioned circumferentially between tooth portions 154, 158. The notch 150 is positioned at a circumferential end 162 of the rim portion 138. In some embodiments, the notches 142, 146 provide clearance for additional components of the motor assembly include, for example, temperature sensors, coil leads, etc.

Various features and advantages are set forth in the following claims.

1. The motor assembly of claim 22, wherein the stator includes
a segmented tooth extending radially inward from the yoke; and wherein the cap includes a tooth portion aligned with the segmented tooth.

2. (canceled)

3. The motor assembly of claim 22, wherein the cap includes a first surface that abuts the winding, a second surface that abuts the winding, and a third surface that abuts the winding.

4. The motor assembly of claim 3, wherein the winding includes an end winding portion that extends from the stator, and wherein the first surface, the second surface, and the third surface of the cap abut the end winding portion.

5. The motor assembly of claim 1, wherein the cap includes a surface that abuts the yoke and the segmented tooth.

6. (canceled)

7. (canceled)

8. (canceled)

9. The motor assembly of claim 1, wherein the cap does not overlap the tooth.

10. (canceled)

11. (canceled)

12. (canceled)

13. The motor assembly of claim 22, further including a housing with a cooling channel positioned within the housing; and wherein an outer cylindrical surface of the cap abuts the housing, and an outer cylindrical surface of the stator abuts the housing.

14. (canceled)

15. The motor assembly of claim 1, wherein the tooth is one of a plurality of integral teeth and the segmented tooth is one of a plurality of segmented teeth, and wherein the cap is one of a plurality of caps; and wherein the plurality of caps is positioned at the axial end surface to form a ring that spans 360 degrees.

16. (canceled)

17. The motor assembly of claim 22, wherein the axial end surface is a first axial end surface and the cap is a first cap, and wherein the yoke further includes a second axial end surface, and the motor assembly further includes a second cap positioned at the second axial end surface.

18. The motor assembly of claim 1, wherein the segmented tooth includes a connection portion that is received within a slot formed in the yoke, and wherein the cap axially overlaps the connection portion and the slot; and wherein no winding is wound around the segmented tooth.

19. (canceled)

20. The motor assembly of claim 1, wherein the tooth portion of the cap is a first tooth portion, and the cap further includes a second tooth portion circumferentially spaced from the first tooth portion, with a receiving space defined between the first tooth portion and the second tooth portion, and wherein the receiving space is configured to at least partially receive the winding; and wherein the rim portion has an outer cylindrical surface and an inner cylindrical surface; and wherein the tooth portion extends from the inner cylindrical surface.

21. (canceled)

22. A motor assembly comprising:
a stator including:
a yoke with an axial end surface,
a tooth extending radially inward from the yoke, and
a winding wound around the tooth; and
a cap positioned at the axial end surface, the cap includes a rim portion aligned with the yoke; wherein the cap is at least partially positioned radially outward from the winding.

23. The motor assembly of claim 22, wherein the cap abuts an end winding portion of the winding.

24. The motor assembly of claim 22, wherein the cap includes a surface that abuts the yoke.

25. (canceled)

26. The motor assembly of claim 22, wherein an outer cylindrical surface of the stator is flush with an outer cylindrical surface of the cap.

27. The motor assembly of claim 22, wherein the rim portion is ring shaped and spans 360 degrees around.

28. The motor assembly of claim 22, wherein the cap is ceramic.

29. The motor assembly of claim 28, wherein the cap is Aluminum Nitride ceramic.

30. The motor assembly of claim 22, further including a housing with a cooling channel positioned within the housing.

31. The motor assembly of claim 30, wherein an outer cylindrical surface of the cap abuts the housing, and an outer cylindrical surface of the stator abuts the housing.

32. The motor assembly of claim 22, wherein the cap is one of a plurality of caps, and wherein the plurality of caps is positioned at the axial end surface to form a ring that spans 360 degrees.
